(19) United States
(12) Patent Application Publication
(10) Pub. No.: US 2018/0189885 A1
(43) Pub. Date: Jul. 5, 2018

(54) Earth Invest Score for Bond Prices

(71) Applicant: Cyrus Afshar, Washington, DC (US)

(72) Inventor: Cyrus Afshar, Washington, DC (US)

(21) Appl. No.: 15/396,369

(22) Filed: Dec. 30, 2016

(51) Int. Cl. G06Q 40/06

(52) U.S. Cl. CPC G06Q 40/06

(57) ABSTRACT

A method for determining whether bonds prices (or a bond price index or bond price indices) are more likely to rise or fall. A plurality of factor scores, based on a plurality of factors, is determined. An aggregate score, based on a plurality of factor scores, is then determined.

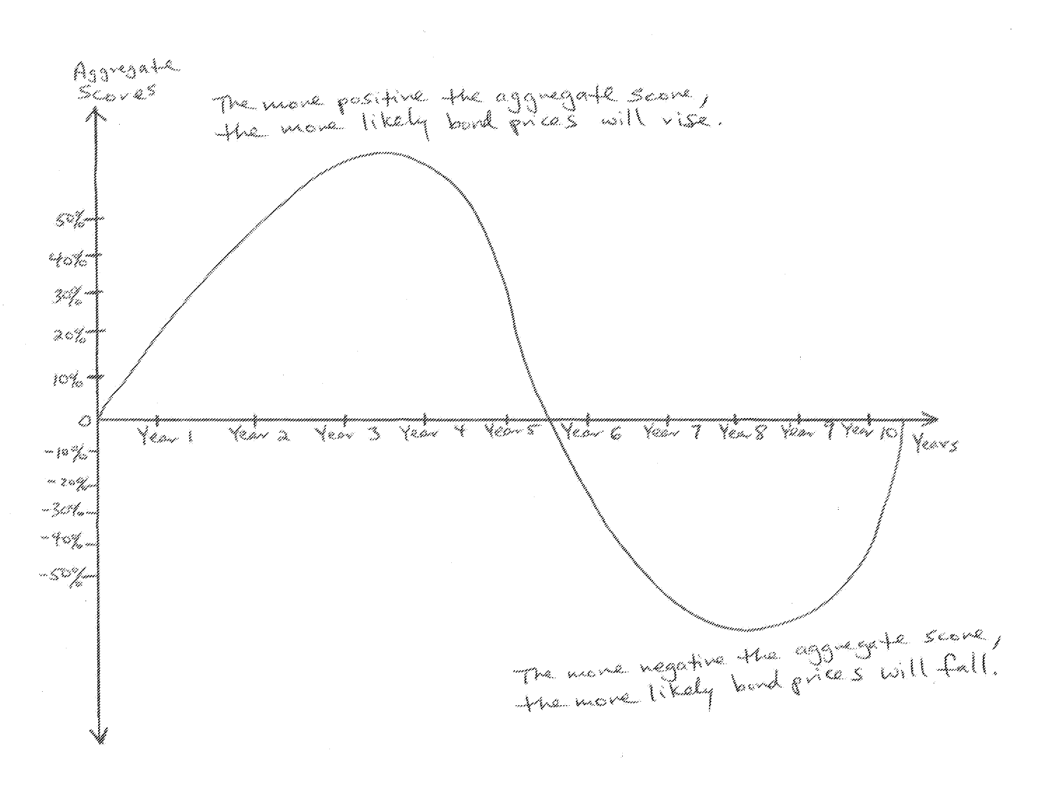

### CROSS-REFERENCE TO RELATED APPLICATIONS

This application claims the benefit of U.S. Provisional Patent Application No. 62/274,156, entitled “Earth Invest Score for Bond Prices,” filed on Dec. 31, 2015.

### BACKGROUND OF THE INVENTION

This invention pertains to investing and most likely belongs in one of the three patent classifications below:
1. Class 705, Subclass 35;
2. Class 705, Subclass 36; or
3. Class 705, Subclass 37.

### BRIEF SUMMARY OF THE INVENTION

Almost all news sources for bond prices (or a bond price index or bond price indices) describe what has already occurred in the market. For example, they'll describe bond price changes that occurred over the previous day or month or quarter or year. These after-the-fact descriptions are not very useful.

The purpose of this invention is to create an aggregate score of useful forward-looking bond prices information.

This invention uses time-tested value investing principles to help identify whether bond prices are more likely to rise or fall. Value investing is based on the notion that there is a long term fundamental value for every investment. In the short term, the market overreacts to good news and bad news, but in the long term, every investment returns to its fundamental value.

This invention helps to identify the long term fundamental value of bond prices by using a ratio of key market variables. This invention compares the current value of this ratio to its historic average to help identify whether bond prices are more likely to rise or fall.

### BRIEF DESCRIPTION OF THE SINGLE VIEW OF THE DRAWING

The drawing portrays exemplary embodiment #1, from the Detailed Description of the Invention, in a graphical form.

The more positive the aggregate score, the more likely bond prices will rise.

The more negative the aggregate score, the more likely bond prices will fall.

### DETAILED DESCRIPTION OF THE INVENTION

Various embodiments of this invention are described below to:
(a) Determine a plurality of factor scores, based on a plurality of factors; and
(b) Determine an aggregate score, based on a plurality of factor scores.
1. In one exemplary embodiment, the following steps are taken:
   Step 1: Current Value
   (a) Calculate (Bond Yield)÷(Treasury Bond Yield).
   Step 2: Historic Value
   (a) Calculate the 5-year trailing average (or 5-year projected average or a hybrid of trailing and projected average) of (Bond Yield)÷(Treasury Bond Yield).
   Step 3: Historic Value
   (a) Calculate the 10-year trailing average (or 10-year projected average or a hybrid of trailing and projected average) of (Bond Yield)÷(Treasury Bond Yield).
   Step 4: Factor Score
   (a) Calculate the percentage difference between Step 1 (a) and Step 2 (a).
      The percentage difference=(Bond Yield)÷(Treasury Bond Yield) compared to 5-year average factor score.
   Step 5: Factor Score
   (a) Calculate the percentage difference between Step 1 (a) and Step 3 (a).
      The percentage difference=(Bond Yield)÷(Treasury Bond Yield) compared to 10-year average factor score.
   Step 6: Aggregate Score
   (a) Calculate the average of Step 4 (a) and Step 5 (a).
      The average of the factor scores=the aggregate score.
      The more positive the aggregate score, the more likely home prices will rise.
      The more negative the aggregate score, the more likely home prices will fall.
2. Alternative embodiments to exemplary embodiment #1 include, instead of using 5-year and 10-year trailing averages (or projected averages or a hybrid of trailing and projected averages), using 1-year, 2-year, 3-year, 4-year, 5-year, 6-year, 7-year, 8-year, 9-year, 10-year, 11-year, 12-year, 13-year, 14-year, 15-year, 16-year, 17-year, 18-year, 19-year, 20-year, 21-year, 22-year, 23-year, 24-year, 25-year, 26-year, 27-year, 28-year, 29-year, 30-year, 31-year, 32-year, 33-year, 34-year, 35-year, 36-year, 37-year, 38-year, 39-year, 40-year, 41-year, 42-year, 43-year, 44-year, 45-year, 46-year, 47-year, 48-year, 49-year, 50-year, 51-year, 52-year, 53-year, 54-year, 55-year, 56-year, 57-year, 58-year, 59-year, 60-year, 61-year, 62-year, 63-year, 64-year, 65-year, 66-year, 67-year, 68-year, 69-year, 70-year, 71-year, 72-year, 73-year, 74-year, 75-year, 76-year, 77-year, 78-year, 79-year, 80-year, 81-year, 82-year, 83-year, 84-year, 85-year, 86-year, 87-year, 88-year, 89-year, 90-year, 91-year, 92-year, 93-year, 94-year, 95-year, 96-year, 97-year, 98-year, 99-year, or 100-year trailing averages (or projected averages or a hybrid of trailing and projected averages).
3. Alternative embodiments to exemplary embodiments #1 or #2 include, instead of calculating the average (or mean), calculating the median, mode, variance, or standard deviation.
4. Alternative embodiments to exemplary embodiments #1, #2, or #3 include, instead of calculating the average (or mean), median, mode, variance, or standard deviation, calculating the weighted average (or mean), weighted median, weighted mode, weighted variance, or weighted standard deviation.

While various embodiments of this invention have been described above, it should be understood that they have been presented by way of example only, and not limitation. Thus, the breadth and scope of this invention should not be limited by any of the above-described embodiments.

What is claimed is:

1. A method for determining whether bond prices (or a bond price index or bond price indices) are more likely to rise or fall, comprising:
(a) Determining a plurality of factor scores, based on a plurality of factors; and
(b) Determining an aggregate score, based on a plurality of factor scores.

2. The method of claim 1, wherein determining a plurality of factor scores comprises an algorithm.

3. The method of claim 1, wherein determining an aggregate score comprises another algorithm.

4. The method of claim 1, wherein based on a plurality of factors comprises:
(a) Bond prices (or a bond price index or bond price indices) for a given period of time;
(b) Bond yield (or bond price index yield or bond price indices yield) for a given period of time; and
(c) Treasury bond yield (or Treasury bond price index yield or Treasury bond price indices yield) for a given period of time.

5. The method of claim 1, wherein based on a plurality of factor scores comprises:
The current value and historical value of the ratio below:
(a) Calculate (Bond Yield)÷(Treasury Bond Yield).

6. The method of claim 2, wherein an algorithm comprises:
Comparing the current value to the historic value of the ratio below:
(a) Calculate (Bond Yield)÷(Treasury Bond Yield).

7. The method of claim 3, wherein another algorithm comprises:
Aggregating the comparison of the current value to the historic value of the ratio below into an aggregate score:
(a) Calculate (Bond Yield)÷(Treasury Bond Yield).

8. The method of claim 4, wherein bond prices (or a bond price index or bond price indices) comprises a measure of bond prices (or a bond price index or bond price indices) for a given period of time.

9. The method of claim 4, wherein bond yield (or bond price index yield or bond price indices yield) comprises a measure of the rate of return of a bond (or a bond price index or bond price indices) for a given period of time and is is often expressed as a bond yield for the trailing day or month or quarter or year, or as a projected bond yield, or as a hybrid of a trailing and projected bond yield.

10. The method of claim 4, wherein Treasury bond Yield (or Treasury bond price index yield or Treasury bond price indices yield) comprises a measure of the rate of return of a Treasury bond (or a Treasury bond price index or Treasury bond price indices) for a given period of time and is often expressed as a Treasury bond yield for the trailing day or month or quarter or year, or as a projected Treasury bond yield, or as a hybrid of a trailing and projected Treasury bond yield.
